(19) United States
(12) Patent Application Publication
(10) Pub. No.: US 2006/0007179 A1
(43) Pub. Date: Jan. 12, 2006

(54) Multi-functional touch actuation in electronic devices

(76) Inventor: Pekka Pihlaja, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/888,802

(22) Filed: Jul. 8, 2004

(51) Int. Cl. G09G 5/00

(52) U.S. Cl. 345/173; 345/161

(57) ABSTRACT

This invention describes a method for a multi-functional touch actuation in an electronic device using a touch-device (e.g., a touch-screen). The touch-device is overlaid with a folding or sliding flap or a permanent cover. The flap or cover comprises analog input devices (or actuators) implemented using, e.g., joysticks, sliders or rotating knobs. The actuator can slide or roll upon the surface of the touch-device. Graphical user interface elements related to the function of the input device can be displayed right next to it on a touch-screen.

### TECHNICAL FIELD

This invention generally relates to electronic touch-devices and more specifically to a multi-functional touch actuation in an electronic device.

### BACKGROUND ART

U.S. Pat. No. 6,492,978, “Keyscreen”, by D. G. Selig et al.; U.S. patent application No. 2003/0098854, “Integrated touchscreen and Keys in Same Matrix”, by E. R. Laliberte, published May 29, 2003; and U.S. Pat. No. 6,636,203, “Keyboard Equivalent Pad Overlay Encasement for a Handheld Electronic Device”, by Y. K. Wong et al. describe what has come to be known as a push-through key. A touch-device is overlaid with a cover or an unfolding flap equipped with keys. As the key is pressed an actuator on its lower surface makes a contact with the touch-device thus providing a signal of a key activation. The key is identified by the detected contact position. Such push-through key is used in, e.g., the Sony-Ericsson P800 smart phone.

FIG. 1 shows an example of a push-through key actuation, per prior art. An actuator (or a push-through key) 12a, having a flexible connection with a cover 14 of an electronic device, is not in a physical contact with a touch-device 10 (as shown on the top), i.e., it is in “off” position. When the actuator 12a is pushed down (as shown on the bottom), it makes the physical contact with the touch-device 10, i.e., it is in “on” position.

However, though the push-through keys have made quite substantial advances, they do not utilize the analog nature of the touch-devices. Particularly, the patents quoted above do not describe actuators which slide or roll relative to the touch-device.

Moreover, the present touch-devices can detect the position of only one contact at a time. Consequently, in resting state the actuators of the overlaid input devices should be elevated from the touch-device surface. Only the input device currently being used should make a contact with the touch-device.

U.S. Pat. No. 5,774,566, “Device for Treating Signals”, by R. Huber et al. describes an audio mixing device, where analog input devices have been placed on a screen so that the values to be adjusted appear on the screen right next to an input device. However, the input devices are not of the push-through type, i.e., they do not engage the touch-screen underneath. Furthermore, Huber et al. only describe adjusting and controlling audio signals.

### DISCLOSURE OF THE INVENTION

The object of the present invention is to provide a methodology for a multi-functional touch actuation in an electronic device using a touch-device.

According to a first aspect of the invention, a method for providing a multi-functional touch actuation in an electronic device, comprises the steps of: applying a manipulation signal to an actuator of the electronic device by the user to communicate a predetermined command to the electronic device; moving the actuator in a plane parallel to a surface of a touch-device of the electronic device within a predetermined area of the touch-device and in a direction perpendicular to the surface of the touch-device using the manipulation signal; and generating an actuator identity signal by the touch-device for providing the predetermined command if the actuator makes a physical contact with the touch-device, wherein the actuator identity signal is indicative of a location of the actuator in the plane and optionally indicative of a force imposed by the actuator on the touch-device, thus providing the multi-functional touch actuation.

According further to the first aspect of the invention, the actuator may not be in the physical contact with the touch-device before the manipulation signal is applied. Still further, if the manipulation signal is no longer applied, the actuator may automatically move out of the physical contact.

Further according to the first aspect of the invention, the moving of said actuator in the plane parallel to the surface of the touch-device may be in a predetermined direction. Further still, the actuator may be moved in the predetermined direction to a pre-selected position first without making the physical contact with the touch-device and then the actuator may be moved in the direction perpendicular to the surface of the touch-device to make the physical contact with the touch-device for generating the actuator identity signal indicative of the pre-selected position.

Still further according to the first aspect of the invention, the actuator may be moved in the direction perpendicular to the surface of the touch-device first to make the physical contact with the touch-device for generating the actuator identity signal and then the actuator may be moved in the plane parallel to the surface of the touch-device within the predetermined area for continuously updating the actuator identity signal as a function of the location of the actuator, while maintaining the physical contact. Yet still further, the actuator may be further moved in the direction perpendicular to the surface of the touch-device out of the physical contact with the touch-device thus interrupting the actuator identity signal and then the actuator may be still further moved to a further location in the plane parallel to the surface of the touch-device within the predetermined area before it is brought again into the physical contact with the touch-device. Yet further still, during the actuator movement in the plane parallel to the surface of the touch-device within the predetermined area for continuously updating the actuator identity signal, the user may optionally receive any combination of audio, video or haptic feedback signals regarding implementing the predetermined command.

According further to the first aspect of the invention, the moving of the actuator in the plane parallel to the surface of the touch-device may have a path of a circle, a straight line or both relative to the touch-device. Further, the actuator may be moved within the circle to a pre-selected position first without making the physical contact with the touch-device and then may be moved in the direction perpendicular to the surface of the touch-device to make the physical contact with the touch-device for generating the actuator identity signal indicative of the pre-selected position.

According still further to the first aspect of the invention, the location of the actuator may be determined by a coordinate in a predetermined direction in the plane parallel to the surface of the touch-device, or a further coordinate in a further predetermined direction perpendicular to the predetermined direction but in the same plane parallel to the surface of the touch-device, or by both the coordinate and the further coordinate.

According further still to the first aspect of the invention, the touch-device may be a resistive touch-screen, a capacitive touch-screen, an optical detection touch-screen or a force-sensitive touch-screen. Still further, the predetermined area may be an icon.

According yet further still to the first aspect of the invention, the manipulation signal may be provided by a mechanical touch of the user using a stylus or a finger.

Yet still further according to the first aspect of the invention, the electronic device may be a wireless portable device, a mobile communication device or a mobile phone.

Still yet further according to the first aspect of the invention, the actuator may be implemented as a slider, a rotating knob or a joystick.

According to a second aspect of the invention, an electronic device for providing a multi-functional touch comprises: an actuator, responsive to a manipulation signal by a user of the electronic device for communicating a predetermined command to the electronic device; and a touch-device, responsive to a physical contact with the actuator, for generating an actuator identity signal used for providing the predetermined command, wherein the actuator, in response to the manipulation signal, moves in a plane parallel to a surface of a touch-device of the electronic device within a predetermined area of the touch-device and in a direction perpendicular to the surface of the touch-device and an actuator identity signal is generated by the touch-device if the actuator makes the physical contact with the touch-device, and wherein the actuator identity signal is indicative of a location of the actuator in the plane and optionally indicative of a force imposed by the actuator on the touch-device, thus providing the multi-functional touch actuation.

According further to the second aspect of the invention, the actuator may not be in the physical contact with the touch-device before the manipulation signal is applied. Still further, if the manipulation signal is no longer applied, the actuator may automatically move out of the physical contact.

Further according to the second aspect of the invention, the moving of the actuator in the plane parallel to the surface of the touch-device is in a predetermined direction. Further still, the actuator may be moved in the predetermined direction to a pre-selected position first without making the physical contact with the touch-device and then the actuator may be moved in the direction perpendicular to the surface of the touch-device to make the physical contact with the touch-device for generating the actuator identity signal indicative of the pre-selected position.

Still further according to the second aspect of the invention, the actuator may be moved in the direction perpendicular to the surface of the touch-device first to make the physical contact with the touch-device for generating the actuator identity signal and then the actuator may be moved in the plane parallel to the surface of the touch-device within the predetermined area for continuously updating the actuator identity signal as a function of the location of the actuator, while maintaining the physical contact. Yet further, the actuator may be further moved in the direction perpendicular to the surface of the touch-device out of the physical contact with the touch-device, thus interrupting the actuator identity signal; and then the actuator may be still further moved to a further location in the plane parallel to the surface of the touch-device within the predetermined area before it is brought again into the physical contact with the touch-device. Yet still further, during the actuator movement in the plane parallel to the surface of the touch-device within the predetermined area for continuously updating the actuator identity signal, the user optionally may receive any combination of audio, video or haptic feedback signals regarding implementing the predetermined command.

According further to the second aspect of the invention, the moving of the actuator in the plane parallel to the surface of the touch-device may have a path of a circle, a straight line or both relative to the touch-device. Further still, the actuator may be moved within the circle to a pre-selected position first without making the physical contact with the touch-device and then may be moved in the direction perpendicular to the surface of the touch-device to make the physical contact with the touch-device for generating the actuator identity signal indicative of the pre-selected position.

According still further to the second aspect of the invention, the location of the actuator may be determined by a coordinate in a predetermined direction in the plane parallel to the surface of the touch-device, or a further coordinate in a further predetermined direction perpendicular to the predetermined direction but in the same plane parallel to the surface of the touch-device, or by both the coordinate and the further coordinate.

According further still to the second aspect of the invention, the touch-device may be a resistive touch-screen, a capacitive touch-screen, an optical detection touch-screen or a force-sensitive touch-screen. Yet further still, the predetermined area may be an icon.

According yet further still to the second aspect of the invention, the manipulation signal may be provided by a mechanical touch of the user using a stylus or a finger.

Yet still further according to the second aspect of the invention, the electronic device may be a wireless portable device, a mobile communication device or a mobile phone. Further, the actuator may be implemented as a slider, a rotating knob or a joystick.

Still yet further according to the second aspect of the invention, the electronic device may further comprise: a permanent cover or a folding or sliding flap, for providing a mechanical support to the actuator. Yet further, the permanent cover or the folding or sliding flap may be transparent or may contain a window next to the actuator such that a graphical user interface element may display a function of the actuator next to the actuator in the window or under the actuator if the actuator and the cover are transparent. Yet further still, the graphical user interface element displaying the function of the actuator may move synchronously with the actuator.

### BRIEF DESCRIPTION OF THE DRAWINGS

For a better understanding of the nature and objects of the present invention, reference is made to the following detailed description taken in conjunction with the following drawings, in which:

FIG. 1 shows an example of an push-through key actuation, per the prior art;

FIG. 2 shows a block diagram of an electronic device having a touch-device for providing a multi-functional touch actuation, according to the present invention;

FIGS. 3a through 3d together show an example demonstrating a performance of a joystick for implementing the present invention;

FIG. 4 show an example of a slider implementation, according to the present invention;

FIG. 5 shows an example of a rotating knob implementation, according to the present invention; and

FIG. 6 shows an example of a slider with a rotating knob implementation, according to the present invention.

### BEST MODE FOR CARRYING OUT THE INVENTION

The present invention provides a new methodology for a multi-functional touch actuation in an electronic device using a touch-device (e.g., a touch-screen).

The touch-device is overlaid with a folding or sliding flap or a permanent cover. The flap or cover comprises analog input devices (or actuators) implemented using, e.g., joysticks, sliders or rotating knobs. The actuator can slide or roll upon the surface of the touch-device. Graphical user interface elements related to the function of the input device can be displayed right next to it on a touch-screen.

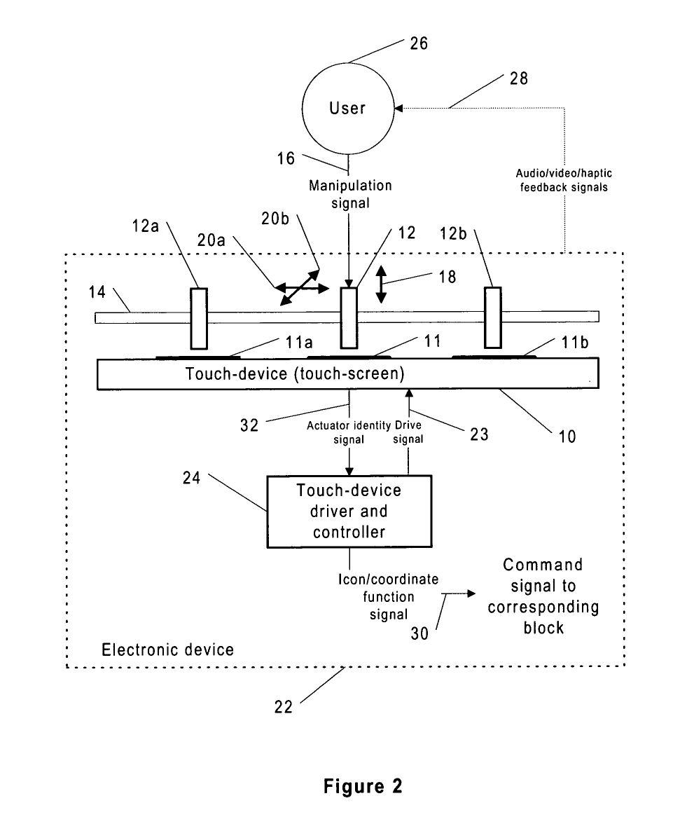

FIG. 2 shows one example among others of a block diagram of an electronic device 22 having a touch-device 10 for providing a multi-functional touch actuation, according to the present invention.

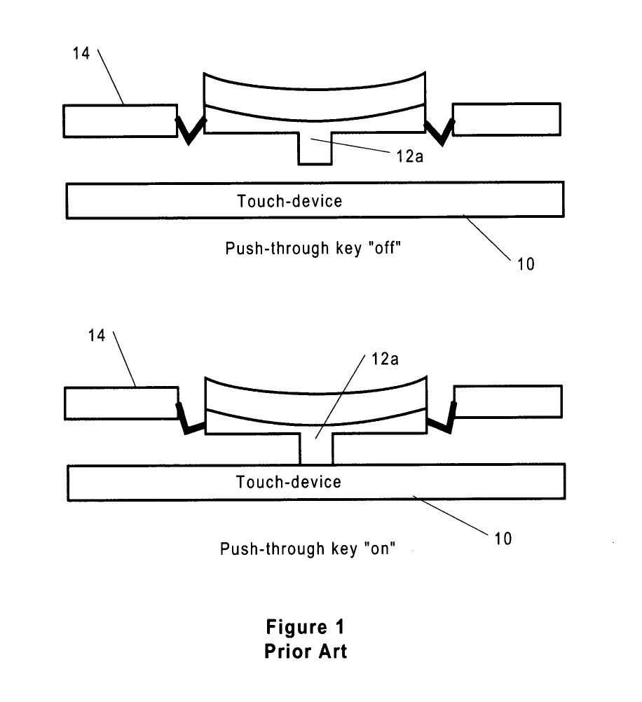

A manipulation signal 16 is applied to an actuator 12 of the electronic device 22 by a user 26 to communicate a predetermined command to the electronic device 22. The manipulation signal 16 can be, e.g., a mechanical touch of the user 26 using a stylus or a finger. The actuator 12, having a “flexible” connection (e.g., see the example of FIG. 1) with a cover 14 of the electronic device 22, can move in a plane parallel (e.g., directions 20a and 20b) to a surface of the touch-device 10 of the electronic device 22 within a predetermined area 11 (also, e.g., areas 11a or 11b as shown in FIG. 2) of said touch-device 10 and in a direction 18 perpendicular to the surface of said touch-device 10 using said manipulation signal 16. If said actuator 12 makes a physical contact with the touch-device 10, an actuator identity signal 32 is generated by the touch-device 10 for providing said predetermined command. This actuator identity signal 32 is indicative of a location of the actuator 10 in said plane and optionally indicative of a force imposed by said actuator 12 on said touch-device 10, thus providing a multi-functional touch actuation.

According to a preferred embodiment of the present invention, the actuator 12 is not in the physical contact with said touch-device 10 before said manipulation signal 16 is applied. However, future touch-devices can be capable of detecting multiple contacts, and consequently some actuators could be in the physical contact with the touch-device all the time.

The actuator 12 can be moved in the plane parallel to the surface of the touch-device 10, e.g., in a predetermined direction 20a to a pre-selected position within a predetermined area 11 first without making the physical contact with the touch-device 10 and then it can be moved in said direction perpendicular to the surface of said touch-device 10 to make the physical contact with the touch-device 10 for generating said actuator identity signal 32 indicative of said pre-selected position.

In an alternative implementation of the present invention, the actuator 12 can be moved in the direction 18 perpendicular to the surface of the touch-device 10 first to make the physical contact with the touch-device 10 for generating the actuator identity signal 32 and then the actuator 12 is moved in the plane parallel to the surface of the touch-device 10 within the predetermined area 11 for continuously updating the actuator identity signal 32 as a function of the location of the actuator 12 in that plane.

Furthermore, after the continuously updating the actuator identity signal 32 by moving the actuator 12 which is in the physical contact with the touch-device 10, the actuator 12 can be further moved in the direction 18 perpendicular to the surface of the touch-device 10 out of said physical contact with said touch-device 10 thus interrupting the actuator identity signal 32 and then the actuator 12 can be still further moved to a further location in the plane parallel to said surface of the touch-device 10 within the predetermined area 11 before it is brought again into the physical contact with the touch-device 10.

The actuator identity signal 32 is provided to a touch-device driver and controller 24 (which provides the touch-device 10 with a drive signal 23). The touch-device driver and controller 24 generates an icon/coordinate function signal 30 providing it as the predetermined command to a corresponding block (e.g., adjusting sound) of the electronic device 22. According to the present invention, during the actuator movement in the plane parallel to said surface of the touch-device 10 within the predetermined area 11 for continuously updating said actuator identity signal 32, the user 26 can receive any combination of audio, video or haptic feedback signals regarding implementing said predetermined command.

There are many possible implementation variations of the present invention. For example, the movement of the actuator 12 in the plane parallel to the surface of the touch-device 10 can have a path of a circle, a straight line or both relative to the touch-device 10. The actuator 12 can be moved within said circle to a pre-selected position first without making said physical contact with the touch-device 10 and then it can be moved in the direction 18 perpendicular to the surface of the touch-device 10 to make the physical contact with the touch-device 10 for generating the actuator identity signal 32 indicative of said pre-selected position.

In another scenario, the actuator 12 location in the plane parallel to the surface of the touch-device 10 is determined by a coordinate in a predetermined direction 20a (e.g., a first movement direction), or a further coordinate in a further predetermined direction 20b (e.g., a second movement direction) perpendicular to said predetermined direction 20a, or by both the coordinate and the further coordinate (e.g., simultaneous movement in two directions 20a and 20b).

Also, according to the present invention, if said manipulation signal 16 is no longer applied, the actuator 12 can be automatically moved out of the physical contact with the touch-device 10 (e.g., using a built-in spring).

The touch-device 10 can be implemented in a variety of ways including but not limited to a resistive touch-screen, a capacitive touch-screen, an optical detection touch-screen, a force-sensitive touch-screen (based on force-sensors placed, e.g., in the corners of the screen), or any other emerging technology. The electronic device 22 can be, for example, a wireless portable device, a mobile communication device or a mobile phone. The actuator 12 can be implemented as a slider, a rotating knob or a joystick.

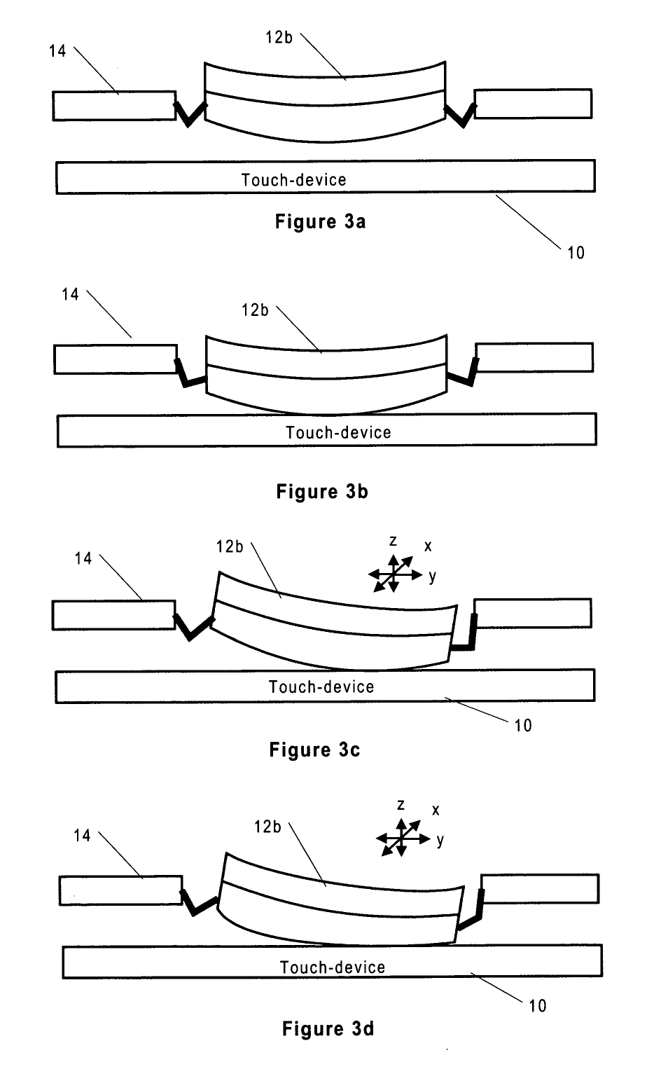

FIGS. 3a-3d, 4-6 demonstrate various implementation scenarios of the present invention.

FIGS. 3a through 3d together show one example among many others demonstrating a performance of a joystick construction for implementing the present invention. In FIGS. 3a and 3b functions of a keytop actuator 12b are similar to the prior art push-through key shown in FIG. 1. In FIG. 3c the keytop actuator 12b is rolled upon the touch-device 10 thus shifting the x,y-coordinates of the contact, which enables using it as a joystick. In FIG. 3d the keytop actuator 12b is depressed harder causing the contact area to increase. This provides the joystick with force-sensitivity in the z-direction.

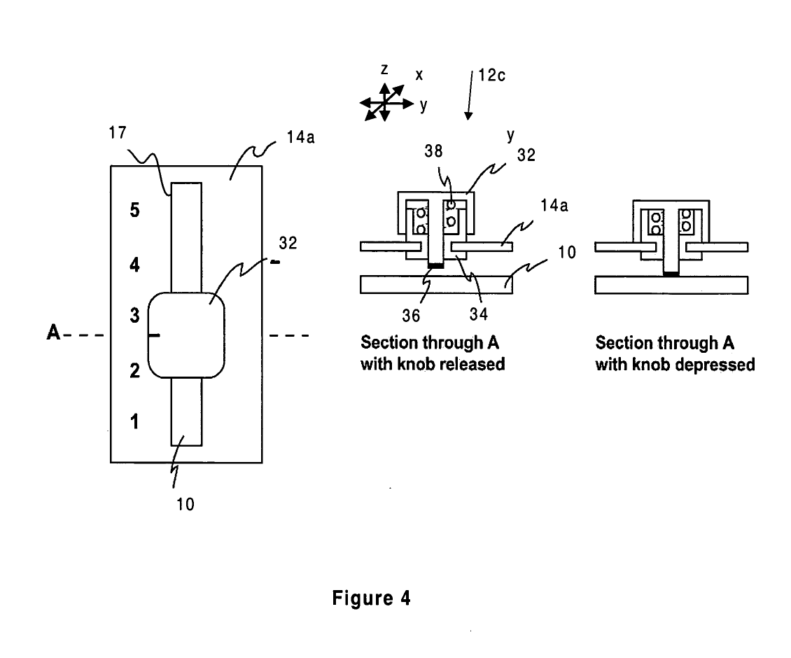

FIG. 4 shows one example among others of a slider implementation, according to the present invention. The actuator (an input device) 12c comprises a slider knob 32 (to which the appropriate manipulation signal 16 is applied by the user 26), a slider carriage 34 (which provides smooth sliding of the actuator 12c over the cover 14a) and a spring 38 (which provides returning of the actuator 12c to a non-contact position after the manipulation signal 16 is no longer applied).

It is noted that the slit 17 made on the cover 14a for the sliding the actuator 12c can double as a window for displaying information. Also, if the actuator nib 36 is made of a soft material and shaped appropriately, the slider knob 32 can be made force-sensitive in the z-direction by detecting the surface area of the contact as described in the previous example above (see FIGS. 3c and 3d).

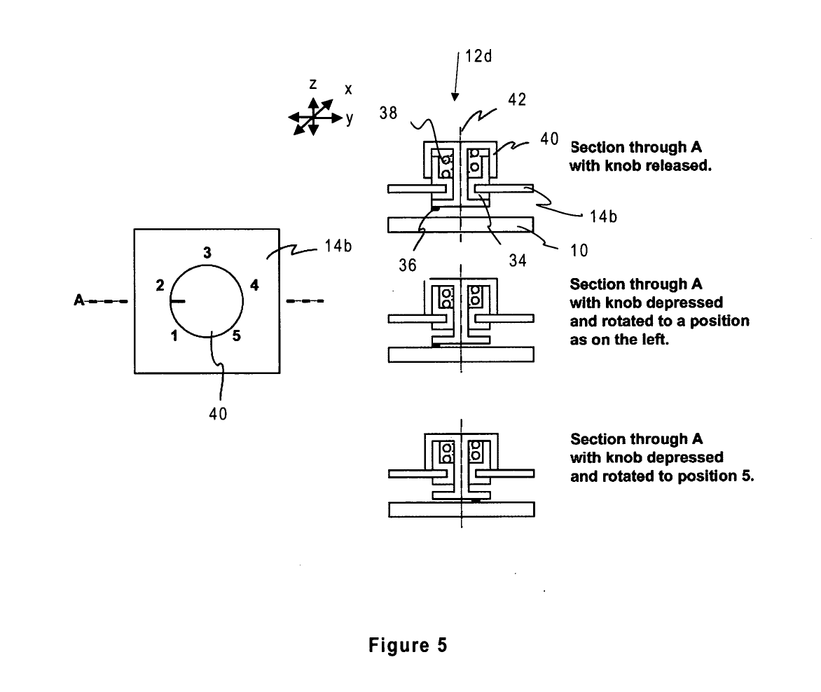

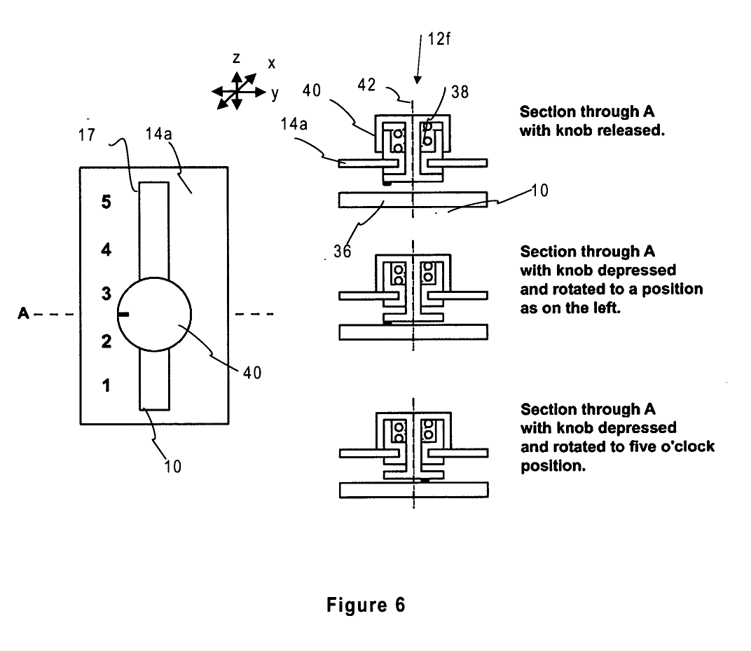

The fact that the input device (the actuator 12c in FIG. 4) must have a released position (with no contact) and a depressed position (with the contact) can be turned into an advantage. It can be facilitated using the input device (e.g., the actuator 12c) with a relative position control mode. According to the present invention, there are three ways of using the input devices 12c shown in FIG. 4 (similarly, this methodology can be applied to examples of FIGS. 5 and 6 described below):
Adjust by an absolute position control. The user depresses, e.g., the slider knob 32 in order to make its contact with the touch-device 10 first and then slides the slider knob 32 along the slit 17 to adjust, e.g., the sound volume. The user can listen to the sound (the feedback signal 28) while adjusting the volume. The volume is directly related to the position of the slider knob 32.
Pre-select and activate. The user slides the slider knob 32 to a pre-selected position indicated by one of the signs (e.g., implemented as a ruler) marked on the cover 14a along the slit 17. At the desired moment (the slider knob 32 is in the desired position) the user activates the desired command by depressing the slider knob 32.
Adjust by a relative position control. The user can, e.g., scroll a long list by depressing the slider knob 32 first and then sliding it, followed by releasing the slider knob 32, moving slider knob 32 to a different position, and then depressing and sliding the slider knob 32 again.

The cover 14a, holding the input devices 12c (it can be more than one input device on the same cover 14a) above the touch-screen 10, can be a mere strip so that the input devices 12c essentially can be surrounded by viewable displays (or windows on the cover 14a next to the input devices 12c). Alternatively, the whole cover 14 and the input devices themselves can be transparent. Thus, a graphical user interface element related to the function of the input device 12c can be displayed right next to or under it. This means that the information displayed on the touch-screen 10 may also have to move with the input device 12c, according to the present invention.

FIG. 5 shows one example among others of a rotating knob implementation, according to the present invention. The input device (an actuator 12d) implementation is similar to the implementation of the actuator 12c of FIG. 4, but with a rotating knob 40 instead of a slider knob 32. Also, an axis 42 here is an axis of rotation of the rotating knob 40. The numbers one through five printed on the cover 14b identify different positions of the rotating knob 40 corresponding to five different locations on the touch device 10 where the actuator nib 36 can touch the touch-device 10.

Again these printed numbers (one through five) can be alternatively shown on the display viewable through a window, according to the present invention.

Finally, FIG. 6 shows another example among many other possible scenarios of a slider with a rotating knob implementation, according to the present invention. This implementation combines implementations shown in FIGS. 4 and 5. The slider with a rotating knob 12f (it can be the same as the rotating knob 12d of FIG. 5) can be used, e.g., for simultaneously adjusting the volume and stereo pan of an audio channel. The knob 12f rotation can be gradated to avoid unintentional rotation. If the rotation is gradated, the stops should be positioned so that they can be recognized based on their unique x-coordinates. If the rotation is analog, only positions between 9 o'clock and 3 o'clock should be allowed in order to avoid an ambiguity.

As can be seen from this example, the present invention can be used to create a wide variety of unique combinational input devices, which cannot be implemented using the prior art methods.

What is claimed is:

1. A method for providing a multi-functional touch actuation in an electronic device, comprising the steps of:
applying a manipulation signal to an actuator of said electronic device by the user to communicate a predetermined command to said electronic device;
moving said actuator in a plane parallel to a surface of a touch-device of the electronic device within a predetermined area of said touch-device and in a direction perpendicular to the surface of said touch-device using said manipulation signal; and
generating an actuator identity signal by said touch-device for providing said predetermined command if said actuator makes a physical contact with said touch-device, wherein said actuator identity signal is indicative of a location of said actuator in said plane and optionally indicative of a force imposed by said actuator on said touch-device, thus providing said multi-functional touch actuation.

2. The method of claim 1, wherein said actuator is not in the physical contact with said touch-device before said manipulation signal is applied.

3. The method of claim 1, wherein said moving of said actuator in the plane parallel to the surface of the touch-device is in a predetermined direction.

4. The method of claim 3, wherein said actuator is moved in said predetermined direction to a pre-selected position first without making said physical contact with said touch-device and then said actuator is moved in said direction perpendicular to the surface of said touch-device to make said physical contact with said touch-device for generating said actuator identity signal indicative of said pre-selected position.

5. The method of claim 1, wherein said actuator is moved in said direction perpendicular to the surface of said touch-device first to make said physical contact with said touch-device for generating said actuator identity signal and then said actuator is moved in the plane parallel to said surface of said touch-device within said predetermined area for continuously updating said actuator identity signal as a function of the location of said actuator, while maintaining said physical contact.

6. The method of claim 5, wherein said actuator is further moved in said direction perpendicular to the surface of said touch-device out of said physical contact with said touch-device thus interrupting said actuator identity signal and then said actuator is still further moved to a further location in the plane parallel to said surface of said touch-device within said predetermined area before it is brought again into said physical contact with said touch-device.

7. The method of claim 5, wherein during said actuator movement in the plane parallel to said surface of said touch-device within said predetermined area for continuously updating said actuator identity signal, the user optionally receives any combination of audio, video or haptic feedback signals regarding implementing said predetermined command.

8. The method of claim 1, wherein said moving of said actuator in the plane parallel to the surface of the touch-device has a path of a circle, a straight line or both relative to said touch-device.

9. The method of claim 8, wherein said actuator is moved within said circle to a pre-selected position first without making said physical contact with said touch-device and then is moved in said direction perpendicular to the surface of said touch-device to make said physical contact with said touch-device for generating said actuator identity signal indicative of said pre-selected position.

10. The method of claim 1, wherein said location is determined by a coordinate in a predetermined direction in the plane parallel to the surface of the touch-device, or a further coordinate in a further predetermined direction perpendicular to the predetermined direction but in the same plane parallel to the surface of the touch-device, or by both the coordinate and the further coordinate.

11. The method of claim 1, wherein, if said manipulation signal is no longer applied, the actuator automatically moves out of said physical contact.

12. The method of claim 1, wherein said touch-device is a resistive touch-screen, a capacitive touch-screen, an optical detection touch-screen or a force-sensitive touch-screen.

13. The method of claim 1, wherein said predetermined area is an icon.

14. The method of claim 1, wherein said manipulation signal is provided by a mechanical touch of the user using a stylus or a finger.

15. The method of claim 1, wherein said electronic device is a wireless portable device, a mobile communication device or a mobile phone.

16. The method of claim 1, wherein said actuator is implemented as a slider, a rotating knob or a joystick.

17. An electronic device for providing a multi-functional touch, comprising:
an actuator, responsive to a manipulation signal by a user of said electronic device for communicating a predetermined command to said electronic device; and
a touch-device, responsive to a physical contact with said actuator, for generating an actuator identity signal used for providing said predetermined command,
wherein said actuator, in response to said manipulation signal, moves in a plane parallel to a surface of a touch-device of the electronic device within a predetermined area of said touch-device and in a direction perpendicular to the surface of said touch-device and an actuator identity signal is generated by said touch-device if said actuator makes said physical contact with said touch-device, and wherein said actuator identity signal is indicative of a location of said actuator in said plane and optionally indicative of a force imposed by said actuator on said touch-device, thus providing said multi-functional touch actuation.

18. The electronic device of claim 17, wherein said actuator is not in the physical contact with said touch-device before said manipulation signal is applied.

19. The electronic device of claim 17, wherein said moving of said actuator in the plane parallel to the surface of the touch-device is in a predetermined direction.

20. The electronic device of claim 19, wherein said actuator is moved in said predetermined direction to a pre-selected position first without making said physical contact with said touch-device and then said actuator is moved in said direction perpendicular to the surface of said touch-device to make said physical contact with said touch-device for generating said actuator identity signal indicative of said pre-selected position.

21. The electronic device of claim 17, wherein said actuator is moved in said direction perpendicular to the surface of said touch-device first to make said physical contact with said touch-device for generating said actuator identity signal and then said actuator is moved in the plane parallel to said surface of said touch-device within said predetermined area for continuously updating said actuator identity signal as a function of the location of said actuator, while maintaining said physical contact.

22. The electronic device of claim 21, wherein said actuator is further moved in said direction perpendicular to the surface of said touch-device out of said physical contact with said touch-device thus interrupting said actuator identity signal and then said actuator is still further moved to a further location in the plane parallel to said surface of said touch-device within said predetermined area before it is brought again into said physical contact with said touch-device.

23. The electronic device of claim 21, wherein during said actuator movement in the plane parallel to said surface of said touch-device within said predetermined area for continuously updating said actuator identity signal, the user optionally receives any combination of audio, video or haptic feedback signals regarding implementing said predetermined command.

24. The electronic device of claim 17, wherein said moving of said actuator in the plane parallel to the surface of the touch-device has a path of a circle, a straight line or both relative to said touch-device.

25. The electronic device of claim 24, wherein said actuator is moved within said circle to a pre-selected position first without making said physical contact with said touch-device and then is moved in said direction perpendicular to the surface of said touch-device to make said physical contact with said touch-device for generating said actuator identity signal indicative of said pre-selected position.

26. The electronic device of claim 17, wherein said location is determined by a coordinate in a predetermined direction in the plane parallel to the surface of the touch-device, or a further coordinate in a further predetermined direction perpendicular to the predetermined direction but in the same plane parallel to the surface of the touch-device, or by both the coordinate and the further coordinate.

27. The electronic device of claim 17, wherein, if said manipulation signal is no longer applied, the actuator automatically moves out of said physical contact.

28. The electronic device of claim 17, wherein said touch-device is a resistive touch-screen, a capacitive touch-screen, an optical detection touch-screen or a force-sensitive touch-screen.

29. The electronic device of claim 17, wherein said predetermined area is an icon.

30. The electronic device of claim 17, wherein said manipulation signal is provided by a mechanical touch of the user using a stylus or a finger.

31. The electronic device of claim 17, wherein said electronic device is a wireless portable device, a mobile communication device or a mobile phone.

32. The electronic device of claim 17, wherein said actuator is implemented as a slider, a rotating knob or a joystick.

33. The electronic device of claim 17, wherein said electronic device further comprises:
a permanent cover or a folding or sliding flap, for providing a mechanical support to said actuator.

34. The electronic device of claim 33, wherein said permanent cover or said folding or sliding flap is transparent or contains a window next to said actuator such that a graphical user interface element displays a function of the actuator next to said actuator in said window or under said actuator if said actuator and said cover are transparent.

35. The electronic device of claim 34, wherein said graphical user interface element displaying said function of the actuator moves synchronously with said actuator.
